(19) United States
(12) Patent Application Publication
(10) Pub. No.: US 2017/0178165 A1
(43) Pub. Date: Jun. 22, 2017

(54) METHOD AND SYSTEM FOR GENERATION OF INDICES REGARDING NEIGHBORHOOD GROWTH

(71) Applicant: MasterCard International Incorporated, Purchase, NY (US)

(72) Inventors: Nadine DAVEY-ROGERS, Miami Shores, FL (US); Serge BERNARD, Danbury, CT (US); Henry WEINBERGER, New York, NY (US); Pavel UMANSKI, Brooklyn, NY (US); Edward LEE, Scarsdale, NY (US)

(73) Assignee: MasterCard International Incorporated, Purchase, NY (US)

(21) Appl. No.: 14/971,177

(22) Filed: Dec. 16, 2015

(51) Int. Cl. G06Q 30/02

(52) U.S. Cl. CPC G06Q 30/0205

(57) ABSTRACT

A method for generating a model for indexing neighborhood growth includes: storing transaction messages, each including a geographic location and transaction data, where the geographic location is in one of a plurality of geographic areas; receiving demographic characteristic data including property value data associated with each geographic area; identifying transaction groups for each geographic area including transaction messages where the geographic location is included in the respective associated geographic area; identifying purchase behaviors for each of the plurality of geographic areas based on the transaction data stored in the transaction messages included in associated transaction group; and generating an indexing model configured to calculate an index value for a geographic area indicative of growth or decline of the geographic area based on the purchase behaviors and property value data associated with the respective geographic area for each of the plurality of geographic areas.

### FIELD

The present disclosure relates to the measurement of growth for a neighborhood, specifically the generation of indices based on neighborhood growth using transaction data and use of the indices to predict neighborhood growth.

### BACKGROUND

Data associated with electronic payment transactions if often desired by a number of entities for a number of uses. Merchants, retailers, content providers, and other such entities often use transaction data captured from electronic payment transactions to determine what products to purchase and/or sell, what type of advertisements to publish, who to distribute advertisements to, etc. A particular set of metrics that many entities may be interested in are metrics associated with a specific geographic location or area.

By learning about transactions in a specific geographic area, merchants may identify opportunities for expansion or advertisement, developers may identify areas for new homes or commercial buildings, small business owners may identify a location to start their businesses, people looking to buy a house may identify a place to settle, etc. However, information captured from transaction data alone can be difficult for many entities to review and analyze, particularly due to the vast number of electronic payment transactions that are processed each day. In addition, the vast amount of detail included in electronic payment transactions may also be difficult for entities to analyze and sort through to identify desired information.

Thus, there is a need for a technical solution to provide detailed analysis of a vast amount of electronic payment transaction data that can distill transaction performance for a geographic area to an index that is readily usable and understandable by a plurality of entities. The generation and use of an index associated with a geographic area may provide for simplified analysis when used by entities that are unable to possess sensitive transactional information and perform the complex calculations and determinations required to analyze such data.

### SUMMARY

The present disclosure provides a description of systems and methods for generating and using indices regarding neighborhood growth.

A method for generating a model for indexing neighborhood growth includes: storing, in a transaction database of a processing server, a plurality of transaction messages, wherein each transaction message is formatted based on one or more standards and includes a plurality of data elements including at least a first data element configured to store a geographic location and one or more additional data elements configured to store transaction data, where the geographic location is included in a geographic area of a plurality of geographic areas; receiving, by a receiving device of the processing server, a data signal electronically transmitted via a communication network, wherein the data signal is superimposed with demographic characteristic data, the demographic characteristic data including at least property value data associated with each geographic area of the plurality of geographic areas; executing, by a querying module of the processing server, a query on the transaction database to identify a plurality of transaction groups, wherein each transaction group is associated with one of the plurality of geographic areas and includes one or more transaction messages where the geographic location stored in the first data element is included in the respective associated geographic area; identifying, by a behavioral scoring module of the processing server, one or more purchase behaviors for each of the plurality of geographic areas, wherein the one or more purchase behaviors are based on at least the transaction data stored in the one or more additional data elements included in each transaction message included in the transaction group associated with the respective geographic area; and generating, by a model generation module, an indexing model configured to calculate an index value for a geographic area indicative of growth or decline of the geographic area based on the identified one or more purchase behaviors and property value data associated with the respective geographic area for each of the plurality of geographic areas.

A method for identifying an index of neighborhood growth for a neighborhood includes: storing, in a transaction database of a processing server, a plurality of transaction messages, wherein each transaction message is formatted based on one or more standards and includes a plurality of data elements including at least a first data element configured to store a geographic location and one or more additional data elements configured to store transaction data; storing, in a model database of the processing server, one or more indexing models, wherein each indexing model is configured to calculate an index value for a geographic area indicative of growth or decline of the geographic area based on transaction data associated with the geographic area; receiving, by a receiving device of the processing server, a data signal electronically transmitted via a communication network, wherein the data signal is superimposed with an index request, the index request including at least a specific geographic area; executing, by a querying module of the processing server, a query on the transaction database to identify a group of transaction messages where the geographic location stored in the first data element included in each transaction message in the group is included in the specific geographic area; identifying, by a behavioral scoring module of the processing server, one or more purchase behaviors for the specific geographic area based on at least the transaction data stored in the one or more additional data elements included in each transaction message included in the identified group of transaction messages; calculating, by an indexing module of the processing server, an index value for the specific geographic area based on application of one of the one or more indexing models to the identified one or more purchase behaviors for the specific geographic area; and electronically transmitting, by a transmitting device of the processing server, a data signal superimposed with the calculated index value.

A system for generating a model for indexing neighborhood growth includes: a transaction database of a processing server configured to store a plurality of transaction messages, wherein each transaction message is formatted based on one or more standards and includes a plurality of data elements including at least a first data element configured to store a geographic location and one or more additional data elements configured to store transaction data, where the geographic location is included in a geographic area of a plurality of geographic areas; a receiving device of the processing server configured to receive a data signal electronically transmitted via a communication network, wherein the data signal is superimposed with demographic characteristic data, the demographic characteristic data including at least property value data associated with each geographic area of the plurality of geographic areas; a querying module of the processing server configured to execute a query on the transaction database to identify a plurality of transaction groups, wherein each transaction group is associated with one of the plurality of geographic areas and includes one or more transaction messages where the geographic location stored in the first data element is included in the respective associated geographic area; a behavioral scoring module of the processing server configured to identify one or more purchase behaviors for each of the plurality of geographic areas, wherein the one or more purchase behaviors are based on at least the transaction data stored in the one or more additional data elements included in each transaction message included in the transaction group associated with the respective geographic area; and a model generation module configured to generate an indexing model configured to calculate an index value for a geographic area indicative of growth or decline of the geographic area based on the identified one or more purchase behaviors and property value data associated with the respective geographic area for each of the plurality of geographic areas.

A system for identifying an index of neighborhood growth for a neighborhood includes: a transaction database of a processing server configured to store a plurality of transaction messages, wherein each transaction message is formatted based on one or more standards and includes a plurality of data elements including at least a first data element configured to store a geographic location and one or more additional data elements configured to store transaction data; a model database of the processing server configured to store one or more indexing models, wherein each indexing model is configured to calculate an index value for a geographic area indicative of growth or decline of the geographic area based on transaction data associated with the geographic area; a receiving device of the processing server configured to receive a data signal electronically transmitted via a communication network, wherein the data signal is superimposed with an index request, the index request including at least a specific geographic area; a querying module of the processing server configured to execute a query on the transaction database to identify a group of transaction messages where the geographic location stored in the first data element included in each transaction message in the group is included in the specific geographic area; a behavioral scoring module of the processing server configured to identify one or more purchase behaviors for the specific geographic area based on at least the transaction data stored in the one or more additional data elements included in each transaction message included in the identified group of transaction messages; an indexing module of the processing server configured to calculate an index value for the specific geographic area based on application of one of the one or more indexing models to the identified one or more purchase behaviors for the specific geographic area; and a transmitting device of the processing server configured to electronically transmit a data signal superimposed with the calculated index value.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for generating and using a model for indexing neighborhood growth in accordance with exemplary embodiments.

FIG. 2 is a block diagram illustrating the processing server of FIG. 1 for the generation and use of models for indexing neighborhood growth in accordance with exemplary embodiments.

FIG. 3 is a flow diagram illustrating a process for the generation of an index and use thereof in determining neighborhood growth in accordance with exemplary embodiments.

FIG. 4 is a diagram illustrating the indexing of neighborhood growth based on transaction, demographic, and social activity data in accordance with exemplary embodiments.

FIG. 5 is a flow chart illustrating an exemplary method for generating a model for indexing neighborhood growth in accordance with exemplary embodiments.

FIG. 6 is a flow chart illustrating an exemplary method for identifying an index of neighborhood growth for a neighborhood in accordance with exemplary embodiments.

FIG. 7 is a flow diagram illustrating the processing of a payment transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant. In some instances, as used herein, the term “merchant” may refer to an apparatus or device of a merchant entity.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Indexing Neighborhood Growth

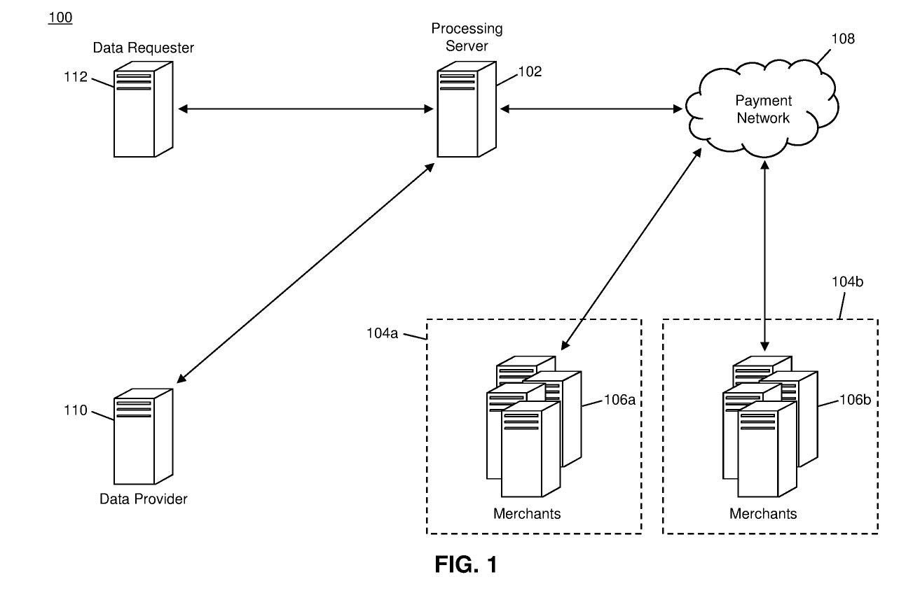

FIG. 1 illustrates a system 100 for the generation of a model for indexing neighborhood growth and use thereof based on electronic transaction data and demographic data.

The system 100 may include a processing server 102. The processing server 102, discussed in more detail below, may be configured to generate a model for indexing neighborhood growth based on at least electronic transaction data and property value data and apply the model to transaction data to identify neighborhood growth. The processing server 102 may be configured to identify transaction data associated with each of a plurality of geographic areas 104, illustrated in FIG. 1 as geographic areas 104a and 104b. Each geographic area 104 may be a neighborhood or other delineated area, which may be determined using any suitable criteria. For example, a geographic area 104 may be a neighborhood based on residential designation, based on utility information, based on geographic markers, based on municipalities, etc. Each geographic area 104 may include a plurality of merchants 106.

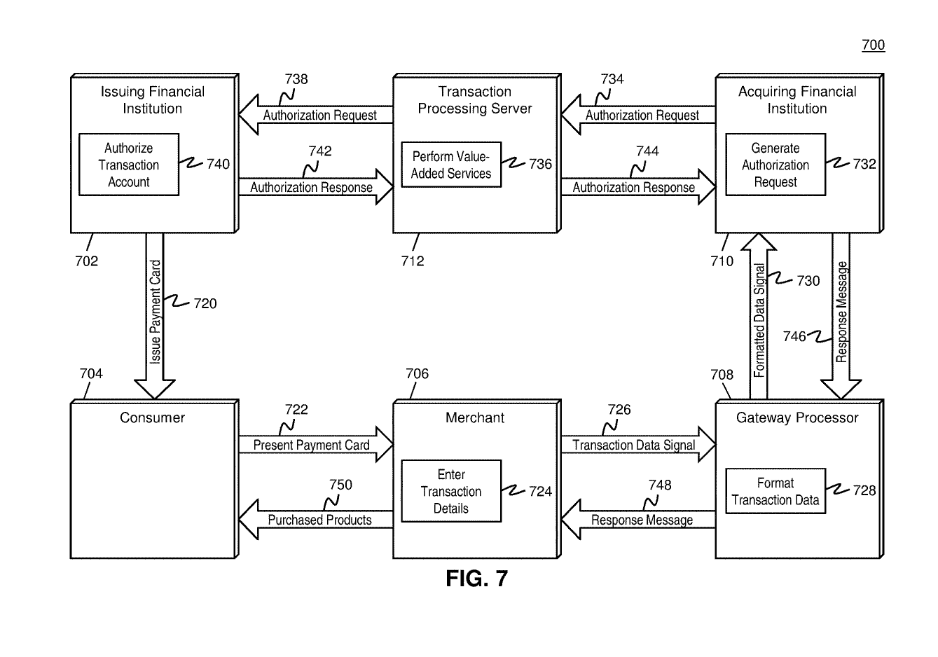

The merchants 106 may participate in payment transactions for the purchase of goods and/or services by consumers. Payment transactions may be processed by one or more payment networks 108. As part of the processing, the merchants 106 may submit transaction data for payment transactions to the payment network 108 via the payment rails. In some instances, the transaction data may be forwarded via one or more intermediate entities, such as a gateway processor or acquiring financial institution. The merchants 106 may submit transaction data in one or more data signals, which may be reformatted by an intermediate entity into a transaction message that is submitted to the payment network 108. Transaction messages may be data messages that are specially formatted pursuant to one or more standards governing the exchange of financial transaction messages, such as the International Organization for Standardization's ISO 8583 standard. Each transaction message may include a plurality of data elements configured to store data as set forth in the associated standard(s) and may also include a message type indicator indicative of a type of transaction message, a bitmap that indicates the number and content of data elements included therein, and additional data. Further information regarding transaction messages and payment rails is discussed in more detail below in respect to the process 700 illustrated in FIG. 7.

The payment network 108 may be configured to forward transaction messages for payment transactions involving the merchants 106 to the processing server 102. In some embodiments, the transaction messages may be forwarded via the payment rails. In other embodiments, the transaction messages may be electronically transmitted via one or more suitable alternative communication networks. In some instances, the processing server 102 may be a part of the payment network 108. In such an instance, the processing server 102 may receive the transaction messages via internal communication of the computing systems of the payment network 108. In some such instances, the processing server 102 may be further configured to perform processing functions of payment transactions for the payment network 108, and may obtain the transaction messages via the associated functions (e.g., by receipt from an acquiring financial institution for processing).

The transaction messages received by the processing server 102 may include at least a first data element configured to store a geographic location associated with the related payment transaction. The geographic location may be represented using latitude and longitude, street address, zip code or postal code, city, or other suitable form of representation. The geographic location may be indicative, equivalent to, or otherwise associated with the geographic area 104 in which the merchant 106 involved in the payment transaction is located. For example, the geographic location may be a street address of the merchant 106 at which the transaction was conducted, which may be a street address in the corresponding neighborhood 104. Each transaction message may also include additional transaction data associated with the related payment transaction, such as a transaction amount, transaction time, transaction date, merchant data (e.g., merchant name, merchant identification number, merchant category code, merchant industry, etc.), product data, consumer data, offer data, reward data, loyalty data, etc.

The processing server 102 may be configured to identify one or more purchased behaviors for each geographic area 104. Purchase behaviors may include behaviors associated with payment transactions and/or consumers based on the transaction data included in the transaction messages associated with the geographic area 104. Purchase behaviors may include, for example, average ticket size, transaction frequency, number of transactions, aggregate ticket size, propensity to spend, etc., and may be identified for more than one criteria, such as overall, per consumer, per group of consumers, per merchant, per merchant industry, a combination thereof, etc.

The processing server 102 may also receive demographic data from one or more data providers 110. Data providers 110 may include, for example, research firms, data collection agencies, governmental agencies, and other entities that may gather and/or possess demographic data associated with the geographic areas 104. The demographic data may be electronically transmitted to the processing server 102 using a suitable communication network, such as the Internet, a local area network, cellular communication network, radio frequency network, etc. The demographic data may include at least property value data associated with property included in the respective geographic area. In some instances, the property value data may include change in property value (e.g., overall for the geographic area 104 and/or individual property values) over time. The demographic data may also include additional data associated with the geographic area, including property data (e.g., property size, property type, etc.), merchant data (e.g., number of merchants, merchant revenue, merchant type, merchant size, etc.), consumer data (e.g., number of consumers, age, gender, income, occupation, education, residential status, familial status, marital status, etc.), etc.

The processing server 102 may be configured to generate a model for indexing neighborhood growth for a geographic area 104. The model may be generated based on at least the purchase behaviors for a geographic area 104 and associated demographic data including at least property value data and may be based on the data for multiple geographic areas 104. For example, the processing server 102 may identify a correspondence between purchase behaviors and property value for multiple geographic areas 104 in a region, between geographic areas 104 with similar demographic characteristics outside of property value (e.g., similar sized areas with similar consumers, etc.). In such instances, the processing server 102 may generate different models for indexing based on different types of geographic areas 104. For example, there may be one model for low population geographic areas 104 and another model for high population geographic areas 104, there may be multiple models for geographic area 104 based on size of the area, etc., and combinations thereof. The indexing model may be based on the correspondence between property value and purchase behaviors to identify purchase behaviors that are associated with historic increases and/or decreases in property value, to identify associations therewith. The historic data can be weighted by its relative age and degree of overlap with the demographics, property values, crime rates, quality of schools and other information identified with respect to the geographic area 104 being analyzed. For example, multiple geographic areas 104 may have an increase in property value as well as an increase in specific purchase behaviors during or shortly before the increase in property value. As such, those specific purchase behaviors may be associated with a likelihood of neighborhood growth. Mathematical modeling of information is described in, for example, “Developing High Quality Data Models,” by Matthew West and Julian Fowler, published by the European Process Industries STEP Technical Liaison Executive (EPISTLE) in 1999, which is herein incorporated by reference in its entirety.

Models generated by the processing server 102 may be configured to generate an index value when applied to transaction data for a geographic area 104, and specifically the purchase behaviors used as leading indicator inputs to the indexing model. The index value may be indicative of a likelihood of growth and/or desirability for a geographic area 104 based on the purchase behaviors and other attributes associated with the geographic area 104, which may be determined using a series of standard multivariate statistical correlations and regressions for historical purchase behaviors (e.g., and other attributes) and changes in property values for the geographic area 104 and additional (e.g., related) geographic areas.

In the system 100, a data requester 112 may electronically transmit a data signal to the processing server 102 that is superimposed with an index value request. The index value request may include a geographic area 104 for which a neighborhood growth index value is requested. The processing server 102 may receive the index value request, identify the geographic area 104, and generate an index value based on the associated purchase behaviors and an indexing model. For example, the processing server 102 may identify transaction messages for payment transactions associated with the geographic area based on the geographic location stored in the corresponding data element included therein, and may identify one or more purchase behaviors based on the transaction data included therein. The processing server 102 may then identify an indexing model suitable for use for the requested geographic area 104. In some embodiments, identifying the indexing model may include identifying demographic characteristics associated with the geographic area 104 and identifying a model associated therewith. In some such instances, the processing server 102 may electronically transmit a data signal to the data provider 110 superimposed with a request for demographic characteristics that includes the geographic area 104, for which the processing server 102 may receive the demographic characteristics in return.

Once the demographic characteristics are identified, the processing server 102 may identify an indexing model for suitable use therewith and may apply the indexing model to the purchase behaviors identified for the geographic area 104. The application may produce an index value associated with the geographic area 104 that is indicative of the likelihood and/or potential of growth of the geographic area 104. For example, the index value may be a value from 0 to 1 or 0 to 100, with the higher value indicating a higher likelihood of growth or a stronger growth in terms of value. In some instances, a negative index value may be possible, which may represent a decline in growth for the neighborhood. In some instances, a positive value scale may be used (e.g., 0 to 100), where a median value (e.g., 50) indicates no growth with numbers below the median indicating negative growth and numbers above the median indicating positive growth. Additional representations of an index value for indicating likelihood and/or potential for growth of a geographic area 104 will be apparent to persons having skill in the relevant art.

The processing server 102 may electronically transmit a data signal superimposed with the identified index value to the data requester 112, in response to the originally received data signal. The data requester 112 may then use the index value accordingly, such as a merchant 106 determining a new geographic area 104 to establish a new location, or a consumer determining an up-and-coming neighborhood to move to. In some instances, the data requester 112 may request index values for a plurality of geographic areas 104, such as for multiple neighborhoods in a city to which a person is looking to move.

In some embodiments, the processing server 102 may also be configured to utilize social activity data in the identification of index values for neighborhood growth. In such embodiments, a data provider 110 may gather social activity data associated with social activity of one or more consumers in a geographic area 104 and electronically transmit the social activity data to the processing server 102. The processing server 102 may associate the social activity data with the geographic area 104 for use thereof in the identification of the indexing models and for use in identifying an index value for a geographic area 104 based thereon. For example, social activity data may be indicative of neighborhood growth or decline based on a correspondence between the social activity data and the property value associated with the geographic area 104 over time. The social activity data may thus be used in conjunction with the purchase behaviors for the geographic area 104 in the identification and application of indexing models. Social activity data may include, for example, location check-ins, location mentions, content distribution, content submission, etc. that may be associated with the geographic area 104.

The systems and methods discussed herein enable the processing server 102 to efficiently and accurately generate a model for indexing neighborhood growth that may be applied to transaction behaviors in order to generate an index for a neighborhood indicative of growth. By utilizing transaction messages related to payment transactions, the purchase behaviors identified by the processing server 102 may be more accurate than transaction data obtained directly from merchants 106, and may also be more complete as it may include a majority of merchants 106 in a geographic area 104 as well as merchants 106 in multiple geographic areas 104. Transaction data and property value data, which may be difficult and/or impossible to obtain and store in traditional computing systems. In addition, traditional computing systems may be unable to efficiently analyze such volumes of transactions, which may number in the millions or billions for some geographic areas 104 or groups thereof. As a result, the index value generated by the processing server 102 may be an efficiently and effective measure of neighborhood growth.

### Processing Server

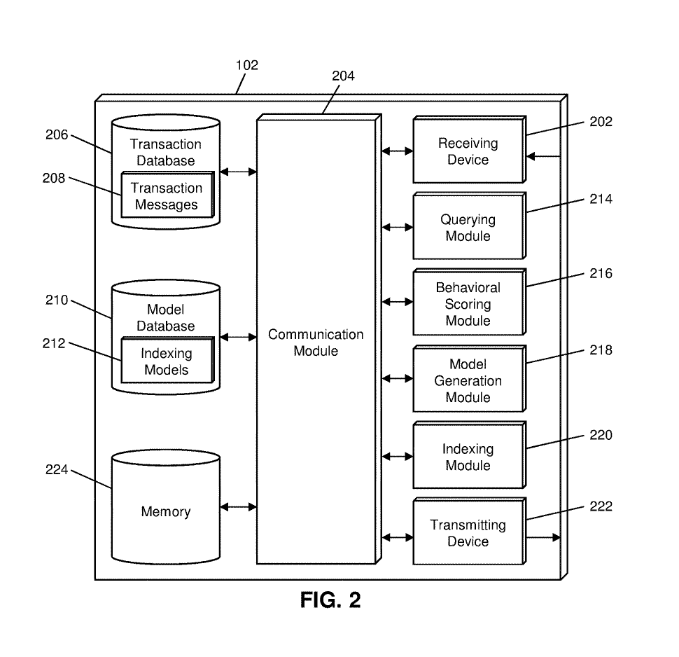

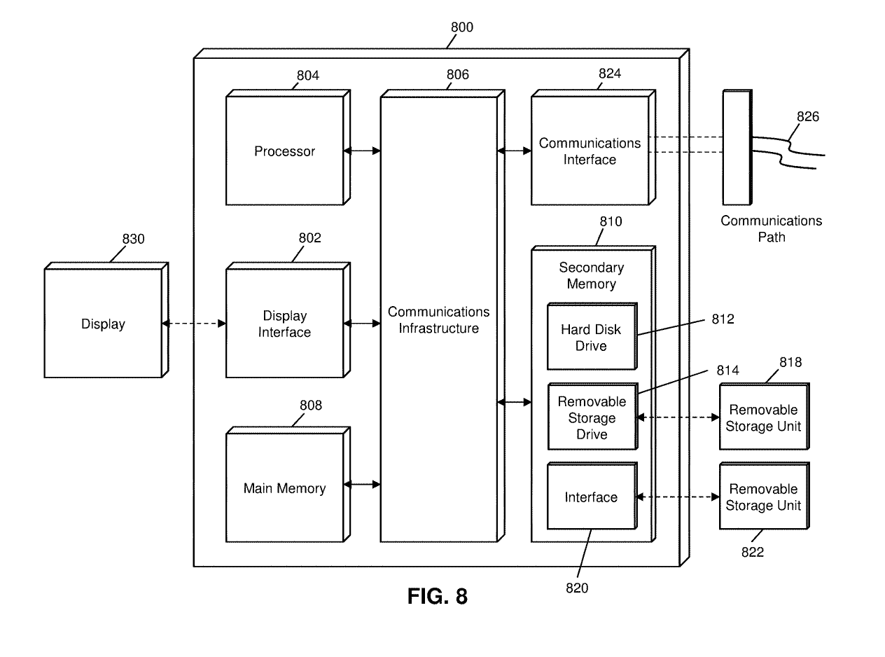

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 108 for the transmission of transaction messages that include sensitive financial data and information. In some instances, the receiving device 202 may also be configured to receive data from merchants 106, payment networks 108, data providers 110, data requesters 112, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals from payment networks 108, which may be electronically transmitted via the payment rails or other suitable communication network, and may be superimposed with or otherwise comprise transaction messages for payment transactions. The receiving device 202 may also receive data signals from data providers 110, which may be superimposed with demographic data and characteristics for geographic areas 104, including property value data for changes in property value over time for the associated geographic area 104. In some instances, data signals received from data providers 110 may also be superimposed with social activity data associated with geographic areas 104. The receiving device 202 may also receive data signals from data requesters 112, which may be superimposed with index requests, which may indicate one or more geographic areas 104 for which an index of neighborhood growth is requested.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, behavioral scoring module 216, model generation module 218, and indexing module 220. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include a transaction database 206. The transaction database 206 may be configured to store a plurality of transaction messages 208 using a suitable data storage format and schema. The transaction database 206 may be a relational database that utilizes structured query language for the storage, identification, modifying, updating, accessing, etc. of structured data sets stored therein. Each transaction message 208 may be a structured data set configured to store data related to a payment transaction, and may be formatted pursuant to one or more standards, such as the ISO 8583 standard. Each transaction message 208 may include at least a first data element configured to store a geographic location and one or more additional data elements configured to store transaction data.

The querying module 214 of the processing server 102 may be configured to execute queries on databases to identify information. The querying module 214 may receive one or more data values or query strings, and may execute a query string based thereon on an indicated database, such as the transaction database 206, to identify information stored therein. The querying module 214 may then output the identified information to an appropriate engine or module of the processing server 102 as necessary. The querying module 214 may, for example, execute a query on the transaction database 206 to identify payment transactions for a predetermined geographic area 104, such as by identifying transaction messages 208 where the geographic location stored in the first data element included therein is included in the geographic area 104. The resulting transaction messages 208 and/or transaction data stored therein may be provided to the behavioral scoring module 216.

The behavioral scoring module 216 may be configured to generate or otherwise identify purchase behaviors for a geographic area 104 based on transaction data. The behavioral scoring module 216 may receive transaction messages 208 and/or transaction data stored therein as input, may analyze the transaction data to determine one or more purchase behaviors based thereon, and may output the resulting purchase behaviors. The purchase behaviors may indicate average ticket size, transaction frequency, number of transactions, aggregate ticket size, propensity to spend, etc., and may be identified for more than one criteria, such as overall, per consumer, per group of consumers, per merchant, per merchant industry, a combination thereof, etc. The behavioral scoring module 216 may output the purchase behaviors for the geographic area 104 to the model generation module 218.

The model generation module 218 may be configured to generate a model for indexing neighborhood growth. The model generation module 218 may receive property value data for one or more geographic areas 104 and the purchase behaviors determined for the one or more geographic areas 104 by the behavioral scoring module 216. The model generation module 218 may then generate an indexing model to generate an index value for a geographic area 104 based on the purchase behaviors for the geographic area 104, which may be generated based on correspondence between the property value data and purchase behaviors for one or more geographic areas 104.

Generation of the indexing model may include the creation of a list of neighborhood (e.g., or other geographic area 104) desirability attributes with statistical functions, such as multivariate correlation, regression, and oblique principal components. For instance, a change in property value may be equated to a statistical function that utilizes restaurant spending, travel spending, entertaining spending, and social network activity. The model generation module 218 may then create indices for each attribute that is determined to be significant as a result of the list of desirability attributes. For instance, in the above example, a restaurant index may be created that is a function of the restaurant spending in a specific geographic area 104 as compared to an average benchmark restaurant spending for all of the geographic areas 104. The model generation module 218 may then create a composite index of all attributes, which may be weighted based on importance assigned to the respective attribute (e.g., by the processing server 102, data requestor 112, etc.). A final index value may then be identified for a geographic area 104, which may be based on the composite index value for the geographic area 104 and the property value for the geographic area 104. In some instances, the model may be configured to rank geographic areas 104 as a result of the final index value, such that a higher index value indicates that the geographic area 104 is more desirable, has greater desirability growth, is more likely to grow, etc. compared to its property value.

In some instances, the indexing model may be based on the correspondence between property value data and purchase behaviors for each of a plurality of geographic areas 104 having similar demographic characteristics. The generated indexing model may be output to the indexing module 220. In embodiments where social activity data may be available, the model generation module 218 may also utilize social activity data for a geographic area 104 in the generation of an indexing model.

In some embodiments, the generated indexing models may be stored in a model database 210 of the processing server 102. The model database 210 may be configured to store a plurality of indexing models 212 using a suitable data storage format and schema. The model database 210 may be a relational database that utilizes structured query language for the storage, identification, modifying, updating, accessing, etc. of structured data sets stored therein. Each indexing model 212 may include one or more algorithms suitable for use in identifying an index value based on one or more purchase behaviors. In some instances, each indexing model 212 may also be associated with one or more demographic characteristics and/or social activity data.

The indexing module 220 may be configured to generate an index value for a geographic area 104 based on purchase behaviors associated therewith. The indexing module 220 may receive purchase behaviors from the behavioral scoring module 216 for a geographic area 104 based on the transaction data associated therewith. The indexing module 220 may also receive an indexing model from the model generation module 218 and/or the querying module 214 (e.g., as identified from the model database 210). In some instances, the indexing model may be based on the demographic characteristics and/or social activity data associated with the geographic area 104 for which the index value is being identified. The indexing module 220 may then apply the identified indexing model to the purchase behaviors and/or social activity data for the geographic area 104 and produce an index value. The index value may then be output to an appropriate device, engine, and/or module of the processing server 102 for use thereof, such as for display to a user, providing to a data requester 112, etc.

The processing server 102 may further include a transmitting device 222. The transmitting device 222 may be configured to transmit data over one or more networks via one or more network protocols. In some embodiments, the transmitting device 222 may be configured to transmit data over the payment rails, such as using specially configured infrastructure associated with payment networks 108 for the transmission of transaction messages that include sensitive financial data and information, such as identified payment credentials. In some instances, the transmitting device 222 may be configured to transmit data to merchants 106, payment networks 108, data providers 110, data requesters 112, and other entities via alternative networks, such as the Internet. In some embodiments, the transmitting device 222 may be comprised of multiple devices, such as different transmitting devices for transmitting data over different networks, such as a first transmitting device for transmitting data over the payment rails and a second transmitting device for transmitting data over the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to payment networks 108 and data providers 110 superimposed with requests for data. For example, the transmitting device 222 may transmit a request for transaction messages to the payment network 108, such as to request transaction messages for a geographic area 104 and/or a period of time. The transmitting device 222 may also transmit a request for demographic characteristics, property value data, and/or social activity data to one or more data providers 110. The transmitting device 222 may also be configured to electronically transmit a data signal to a data requester 112 or other entity in response to a request for an index value. The electronically transmitted data signal may be superimposed with an index value identified by the indexing module 220.

The processing server 102 may also include a memory 224. The memory 224 may be configured to store data for use by the processing server 102 in performing the functions discussed herein. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art.

### Process for Indexing Neighborhood Growth

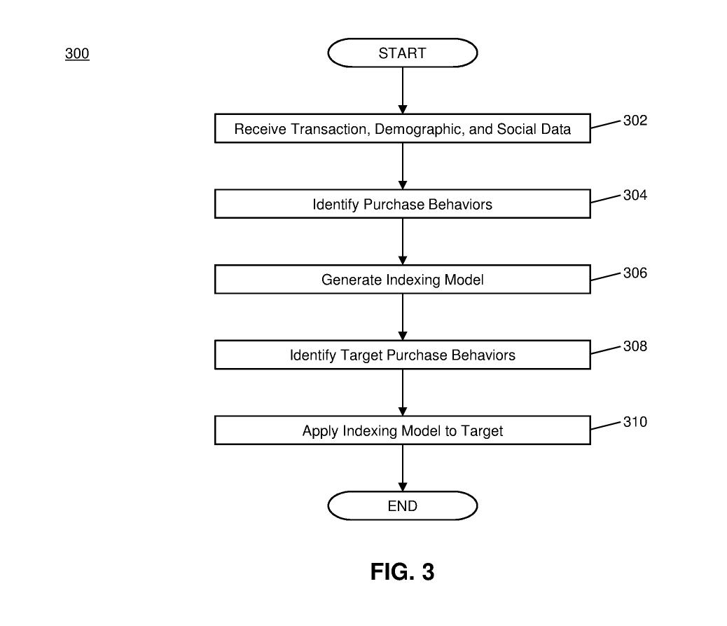

FIG. 3 illustrates a process 300 for the generation of a model for indexing neighborhood growth and use thereof in identifying an index of neighborhood growth for a geographic area based on transaction behavior and social activity.

In step 302, the receiving device 202 of the processing server 102 may receive transaction, demographic, and social activity data. The transaction data may be received as a plurality of transaction messages provided by the payment network 108 via the payment rails. Each transaction message may include at least a first data element configured to store a geographic location and one or more additional data elements configured to store additional transaction data. Each geographic location may be included in one of a plurality of geographic areas 104. The demographic data and social activity data may be electronically transmitted to the processing server 102 by one or more data providers 110. Demographic data may include at least property value data for each of the plurality of geographic areas 104.

In step 304, the behavioral scoring module 216 of the processing server 102 may identify purchase behaviors for each of the plurality of geographic areas. The purchase behaviors may be based on at least the transaction data stored in the additional data elements included in each transaction message for the respective geographic area 104 where the geographic location stored in the corresponding data element in the transaction message is included in the respective geographic area 104. In step 306, the model generation module 218 of the processing server 102 may generate an indexing model. The indexing model may be based on at least a correspondence between the demographic data and purchase behaviors and social activity data for each of the plurality of geographic areas 104, and may be configured to produce an index value indicative of neighborhood growth based on associated purchase behaviors and social activity data.

In step 308, the processing server 102 may identify purchase behaviors and social activity data for a target geographic area 104. In some instances, the target geographic area 104 may be identified in an index value request superimposed on a data signal electronically transmitted by a data requester 112 and received by the receiving device 202 of the processing server 102. In some instances, the social activity data may be requested via electronic transmission of a data signal from the transmitting device 222 of the processing server 102 to a data provider 110 and subsequently received by the receiving device 202. The purchase behaviors may be identified by the behavioral scoring module 216 from transaction messages associated with the target geographic area 104.

In step 310, the indexing module 220 may identify an index value for the target geographic area 104 by applying the identified indexing model to the purchase behaviors and social activity data associated with the target geographic area 104. In some embodiments, the transmitting device 222 may electronically transmit a data signal superimposed with the identified index value, such as to the data requester 112 in response to an earlier received index value request.

### Neighborhood Index Values

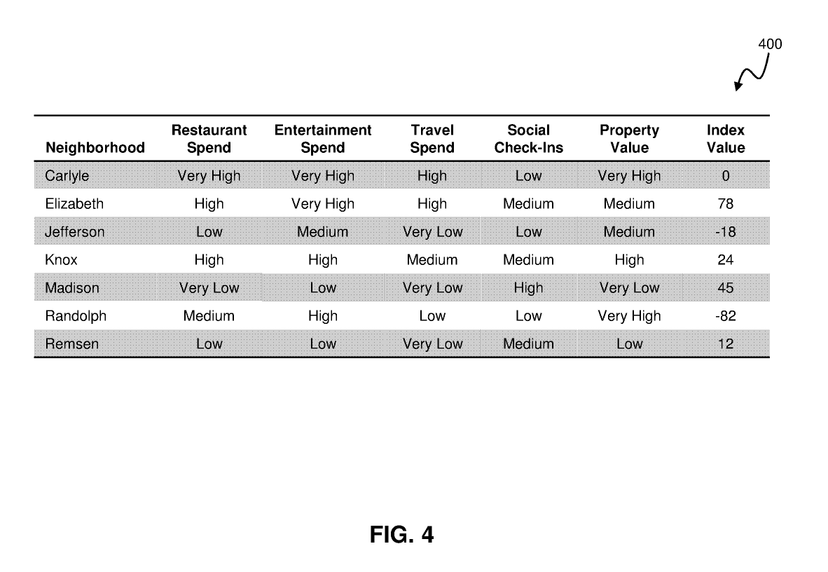

FIG. 4 illustrates the indexing of a plurality of geographic areas 104 based on associated purchase behaviors and social activity data.

The table 400 illustrates a plurality of geographic areas 104. Each geographic area 104 includes three purchase behaviors, restaurant spend, entertainment spend, and travel spend, which may indicate an amount of spending for the associated merchant industries for consumers included in the respective geographic area 104. Each geographic area 104 may also include social activity data, which may comprise social check-ins to geographic locations in the respective geographic area 104, and property value data for the geographic area 104.

The processing server 102 may use the methods discussed herein to generate an index value for each of the geographic areas 104, illustrated in FIG. 4. The index value may indicate the likelihood, potential, and/or estimated amount of growth for the respective geographic area. In the example illustrated in FIG. 4, the index value may be a value in a −100 to 100 scale, where 0 indicates no growth, a negative value may indicate a decline for the neighborhood, and a positive value may indicate positive growth, expansion, increase in property value, etc.

In the example illustrated in FIG. 4, each of the geographic areas 104 includes an index value indicative of their likelihood of growth or decline based on the purchase behaviors and social activity data. The Carlyle neighborhood has very high property values and high or very high spending in each category, with low social activity, and is therefore indicated to remain at its current growth level. The Elizabeth neighborhood has only medium property value but has high or very high spending in each category, with moderate social activity, and thus indicates a high potential for growth with a corresponding index value of 78. Conversely, the Randolph neighborhood has very high property values, but significantly lower spending and low social activity, indicating a forthcoming decline with an index value of −82.

### Exemplary Method for Generating a Model for Indexing Neighborhood Growth

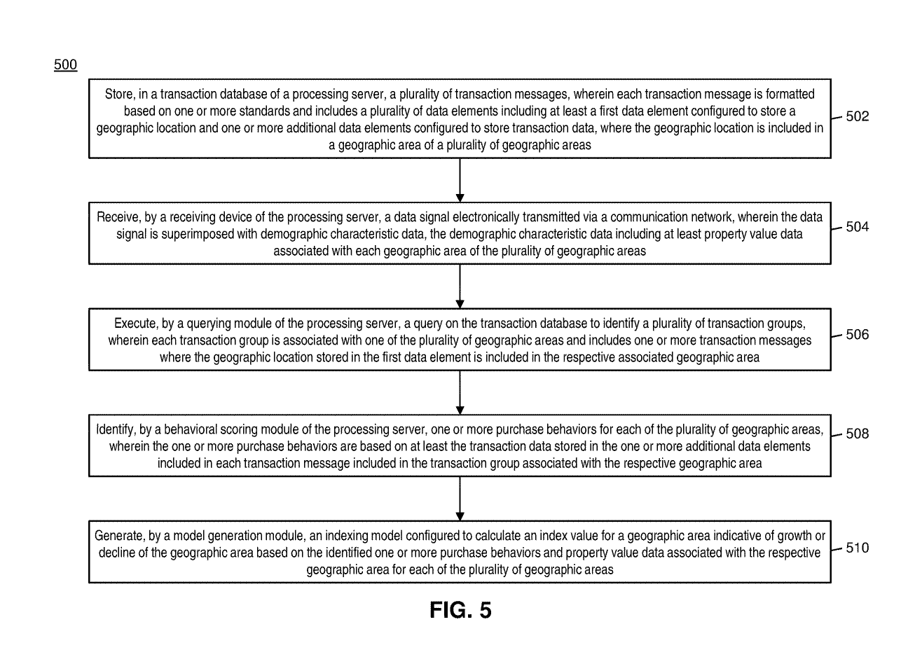

FIG. 5 illustrates a method 500 for the generation of a model for indexing neighborhood growth based on property value data and purchase behaviors from captured transaction messages for a plurality of geographic areas.

In step 502, a plurality of transaction messages (e.g., transaction messages 208) may be stored in a transaction database (e.g., the transaction database 206) of a processing server (e.g., the processing server 102), wherein each transaction message is formatted based on one or more standards and includes a plurality of data elements including at least a first data element configured to store a geographic location and one or more additional data elements configured to store transaction data, where the geographic location is included in a geographic area (e.g., the geographic area 104) of a plurality of geographic areas. In step 504, a data signal electronically transmitted via a communication network may be received by a receiving device (e.g., the receiving device 202) of the processing server, wherein the data signal is superimposed with demographic characteristic data, the demographic characteristic data including at least property value data associated with each geographic area of the plurality of geographic areas.

In step 506, a query may be executed on the transaction database by a querying module (e.g., the querying module 214) of the processing server to identify a plurality of transaction groups, wherein each transaction group is associated with one of the plurality of geographic areas and includes one or more transaction messages where the geographic location stored in the first data element is included in the respective associated geographic area. In step 508, one or more purchase behaviors may be identified by a behavioral scoring module (e.g., the behavioral scoring module 216) of the processing server for each of the plurality of geographic areas, wherein the one or more purchase behaviors are based on at least the transaction data stored in the one or more additional data elements included in each transaction message included in the transaction group associated with the respective geographic area.

In step 510, a model generation module (e.g., the model generation module 218) of the processing server may generate an indexing model configured to calculate an index value for a geographic area indicative of growth or decline of the geographic area based on the identified one or more purchase behaviors and property value data associated with the respective geographic area for each of the plurality of geographic areas. In one embodiment, the demographic characteristic data may further include a plurality of demographic characteristics associated with each geographic area of the plurality of geographic areas. In some embodiments, each geographic area of the plurality of geographic areas may be associated with a common set of demographic characteristics.

In one embodiment, the method 500 may further include receiving, by the receiving device of the processing server, a data signal electronically transmitted via the communication network, wherein the data signal is superimposed with social network data, the social network data including at least social activity data associated with each geographic area of the plurality of geographic areas, wherein the indexing model is further based on the social activity data associated with the respective geographic area for each of the plurality of geographic areas. In a further embodiment, the social activity data may include at least one of: mentions of the associated geographic area, check-ins at a geographic location in the associated geographic area, and selection of content associated with the associated geographic area.

### Exemplary Method for Identifying an Index of Neighborhood Growth for a Neighborhood

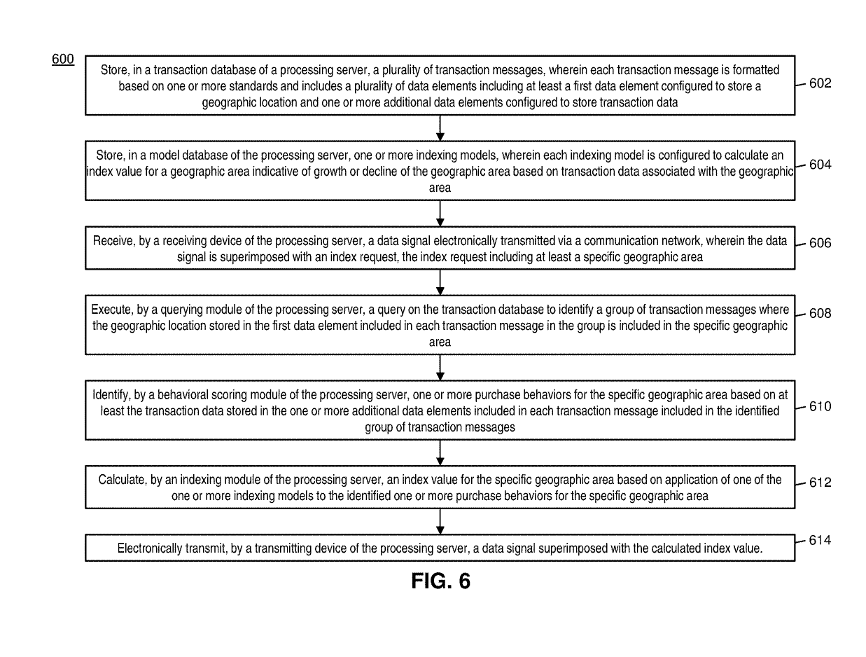

FIG. 6 illustrates a method 600 for the identification of an index for neighborhood growth for a geographic area based on at least transaction behavior identified from captured transaction messages.

In step 602, a plurality of transaction messages (e.g., transaction messages 208) may be stored in a transaction database (e.g., the transaction database 206) of a processing server (e.g., the processing server 102), wherein each transaction message is formatted based on one or more standards and includes a plurality of data elements including at least a first data element configured to store a geographic location and one or more additional data elements configured to store transaction data. In step 604, one or more indexing models (e.g., indexing models 212) may be stored in a model database (e.g., the model database 210) of the processing server, wherein each indexing model is configured to calculate an index value for a geographic area (e.g., geographic area 104) indicative of growth or decline of the geographic area based on transaction data associated with the geographic area.

In step 606, a data signal electronically transmitted via a communication network may be received by a receiving device (e.g., the receiving device 202) of the processing server, wherein the data signal is superimposed with an index request, the index request including at least a specific geographic area. In step 608, a query may be executed on the transaction database by a querying module (e.g., the querying module 214) of the processing server to identify a group of transaction messages where the geographic location stored in the first data element included in each transaction message in the group is included in the specific geographic area.

In step 610, one or more purchase behaviors may be identified by a behavioral scoring module (e.g., the behavioral scoring module 216) of the processing server for the specific geographic area based on at least the transaction data stored in the one or more additional data elements included in each transaction message included in the identified group of transaction messages. In step 612, an index value for the specific geographic area may be calculated by an indexing module (e.g., the indexing module 220) of the processing server based on application of one of the one or more indexing models to the identified one or more purchase behaviors for the specific geographic area. In step 614, a data signal superimposed with the calculated index value may be electronically transmitted by a transmitting device (e.g., the transmitting device 222) of the processing server.

In one embodiment, the method 600 may further include receiving, by the receiving device of the processing server, a data signal electronically transmitted via a communication network, wherein the data signal is superimposed with demographic characteristic data, the demographic characteristic data including at least a plurality of demographic characteristics associated with the specific geographic area, wherein each indexing model of the one or more indexing models may be associated with one or more demographic characteristics, and the one or more demographic characteristics associated with the one of the one or more indexing models applied to the identified one or more purchase behaviors may be included in the plurality of demographic characteristics associated with the specific geographic area. In a further embodiment the data signal superimposed with demographic characteristic data and the data signal superimposed with the index request may be a single data signal

In some embodiments, the method 600 may also include receiving, by the receiving device of the processing server, a data signal electronically transmitted via the communication network, wherein the data signal is superimposed with social network data, the social network data including at least social activity data associated with the specific geographic area. In a further embodiment, the calculated index value may be further based on application of the one of the one or more indexing models to the social activity data associated with the specific geographic area.

### Payment Transaction Processing System and Process

FIG. 7 illustrates a transaction processing system and a process 700 for the processing of payment transactions in the system. The process 700 and steps included therein may be performed by one or more components of the system 100 discussed above, such as the processing server 102, merchants 106, payment network 108, etc. The processing of payment transactions using the system and process 700 illustrated in FIG. 7 and discussed below may utilize the payment rails, which may be comprised of the computing devices and infrastructure utilized to perform the steps of the process 700 as specially configured and programmed by the entities discussed below, including the transaction processing server 712, which may be associated with one or more payment networks configured to processing payment transactions. It will be apparent to persons having skill in the relevant art that the process 700 may be incorporated into the processes illustrated in FIGS. 3, 5, and 6, discussed above, with respect to the step or steps involved in the processing of a payment transaction. In addition, the entities discussed herein for performing the process 700 may include one or more computing devices or systems configured to perform the functions discussed below. For instance, the merchant 706 may be comprised of one or more point of sale devices, a local communication network, a computing server, and other devices configured to perform the functions discussed below.

In step 720, an issuing financial institution 702 may issue a payment card or other suitable payment instrument to a consumer 704. The issuing financial institution may be a financial institution, such as a bank, or other suitable type of entity that administers and manages payment accounts and/or payment instruments for use with payment accounts that can be used to fund payment transactions. The consumer 704 may have a transaction account with the issuing financial institution 702 for which the issued payment card is associated, such that, when used in a payment transaction, the payment transaction is funded by the associated transaction account. In some embodiments, the payment card may be issued to the consumer 704 physically. In other embodiments, the payment card may be a virtual payment card or otherwise provisioned to the consumer 704 in an electronic format.

In step 722, the consumer 704 may present the issued payment card to a merchant 706 for use in funding a payment transaction. The merchant 706 may be a business, another consumer, or any entity that may engage in a payment transaction with the consumer 704. The payment card may be presented by the consumer 704 via providing the physical card to the merchant 706, electronically transmitting (e.g., via near field communication, wireless transmission, or other suitable electronic transmission type and protocol) payment details for the payment card, or initiating transmission of payment details to the merchant 706 via a third party. The merchant 706 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 724, the merchant 706 may enter transaction details into a point of sale computing system. The transaction details may include the payment details provided by the consumer 704 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 706 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 706 may be an online retailer in an e-commerce transaction. In such embodiments, the transaction details may be entered in a shopping cart or other repository for storing transaction data in an electronic transaction as will be apparent to persons having skill in the relevant art.

In step 726, the merchant 706 may electronically transmit a data signal superimposed with transaction data to a gateway processor 708. The gateway processor 708 may be an entity configured to receive transaction details from a merchant 706 for formatting and transmission to an acquiring financial institution 710. In some instances, a gateway processor 708 may be associated with a plurality of merchants 706 and a plurality of acquiring financial institutions 710. In such instances, the gateway processor 708 may receive transaction details for a plurality of different transactions involving various merchants, which may be forwarded on to appropriate acquiring financial institutions 710. By having relationships with multiple acquiring financial institutions 710 and having the requisite infrastructure to communicate with financial institutions using the payment rails, such as using application programming interfaces associated with the gateway processor 708 or financial institutions used for the submission, receipt, and retrieval of data, a gateway processor 708 may act as an intermediary for a merchant 706 to be able to conduct payment transactions via a single communication channel and format with the gateway processor 708, without having to maintain relationships with multiple acquiring financial institutions 710 and payment processors and the hardware associated thereto. Acquiring financial institutions 710 may be financial institutions, such as banks, or other entities that administers and manages payment accounts and/or payment instruments for use with payment accounts. In some instances, acquiring financial institutions 710 may manage transaction accounts for merchants 706. In some cases, a single financial institution may operate as both an issuing financial institution 702 and an acquiring financial institution 710.

The data signal transmitted from the merchant 706 to the gateway processor 708 may be superimposed with the transaction details for the payment transaction, which may be formatted based on one or more standards. In some embodiments, the standards may be set forth by the gateway processor 708, which may use a unique, proprietary format for the transmission of transaction data to/from the gateway processor 708. In other embodiments, a public standard may be used, such as the International Organization for Standardization's ISO 8783 standard. The standard may indicate the types of data that may be included, the formatting of the data, how the data is to be stored and transmitted, and other criteria for the transmission of the transaction data to the gateway processor 708.

In step 728, the gateway processor 708 may parse the transaction data signal to obtain the transaction data superimposed thereon and may format the transaction data as necessary. The formatting of the transaction data may be performed by the gateway processor 708 based on the proprietary standards of the gateway processor 708 or an acquiring financial institution 710 associated with the payment transaction. The proprietary standards may specify the type of data included in the transaction data and the format for storage and transmission of the data. The acquiring financial institution 710 may be identified by the gateway processor 708 using the transaction data, such as by parsing the transaction data (e.g., deconstructing into data elements) to obtain an account identifier included therein associated with the acquiring financial institution 710. In some instances, the gateway processor 708 may then format the transaction data based on the identified acquiring financial institution 710, such as to comply with standards of formatting specified by the acquiring financial institution 710. In some embodiments, the identified acquiring financial institution 710 may be associated with the merchant 706 involved in the payment transaction, and, in some cases, may manage a transaction account associated with the merchant 706.

In step 730, the gateway processor 708 may electronically transmit a data signal superimposed with the formatted transaction data to the identified acquiring financial institution 710. The acquiring financial institution 710 may receive the data signal and parse the signal to obtain the formatted transaction data superimposed thereon. In step 732, the acquiring financial institution may generate an authorization request for the payment transaction based on the formatted transaction data. The authorization request may be a specially formatted transaction message that is formatted pursuant to one or more standards, such as the ISO 8783 standard and standards set forth by a payment processor used to process the payment transaction, such as a payment network. The authorization request may be a transaction message that includes a message type indicator indicative of an authorization request, which may indicate that the merchant 706 involved in the payment transaction is requesting payment or a promise of payment from the issuing financial institution 702 for the transaction. The authorization request may include a plurality of data elements, each data element being configured to store data as set forth in the associated standards, such as for storing an account number, application cryptogram, transaction amount, issuing financial institution 702 information, etc.

In step 734, the acquiring financial institution 710 may electronically transmit the authorization request to a transaction processing server 712 for processing. The transaction processing server 712 may be comprised of one or more computing devices as part of a payment network configured to process payment transactions. In some embodiments, the authorization request may be transmitted by a transaction processor at the acquiring financial institution 710 or other entity associated with the acquiring financial institution. The transaction processor may be one or more computing devices that include a plurality of communication channels for communication with the transaction processing server 712 for the transmission of transaction messages and other data to and from the transaction processing server 712. In some embodiments, the payment network associated with the transaction processing server 712 may own or operate each transaction processor such that the payment network may maintain control over the communication of transaction messages to and from the transaction processing server 712 for network and informational security.

In step 736, the transaction processing server 712 may perform value-added services for the payment transaction. Value-added services may be services specified by the issuing financial institution 702 that may provide additional value to the issuing financial institution 702 or the consumer 704 in the processing of payment transactions. Value-added services may include, for example, fraud scoring, transaction or account controls, account number mapping, offer redemption, loyalty processing, etc. For instance, when the transaction processing server 712 receives the transaction, a fraud score for the transaction may be calculated based on the data included therein and one or more fraud scoring algorithms and/or engines. In some instances, the transaction processing server 712 may first identify the issuing financial institution 702 associated with the transaction, and then identify any services indicated by the issuing financial institution 702 to be performed. The issuing financial institution 702 may be identified, for example, by data included in a specific data element included in the authorization request, such as an issuer identification number. In another example, the issuing financial institution 702 may be identified by the primary account number stored in the authorization request, such as by using a portion of the primary account number (e.g., a bank identification number) for identification.

In step 738, the transaction processing server 712 may electronically transmit the authorization request to the issuing financial institution 702. In some instances, the authorization request may be modified, or additional data included in or transmitted accompanying the authorization request as a result of the performance of value-added services by the transaction processing server 712. In some embodiments, the authorization request may be transmitted to a transaction processor (e.g., owned or operated by the transaction processing server 712) situated at the issuing financial institution 702 or an entity associated thereof, which may forward the authorization request to the issuing financial institution 702.

In step 740, the issuing financial institution 702 may authorize the transaction account for payment of the payment transaction. The authorization may be based on an available credit amount for the transaction account and the transaction amount for the payment transaction, fraud scores provided by the transaction processing server 712, and other considerations that will be apparent to persons having skill in the relevant art. The issuing financial institution 702 may modify the authorization request to include a response code indicating approval (e.g., or denial if the transaction is to be denied) of the payment transaction. The issuing financial institution 702 may also modify a message type indicator for the transaction message to indicate that the transaction message is changed to be an authorization response. In step 742, the issuing financial institution 702 may transmit (e.g., via a transaction processor) the authorization response to the transaction processing server 712.

In step 744, the transaction processing server 712 may forward the authorization response to the acquiring financial institution 710 (e.g., via a transaction processor). In step 746, the acquiring financial institution may generate a response message indicating approval or denial of the payment transaction as indicated in the response code of the authorization response, and may transmit the response message to the gateway processor 708 using the standards and protocols set forth by the gateway processor 708. In step 748, the gateway processor 708 may forward the response message to the merchant 706 using the appropriate standards and protocols. In step 750, assuming the transaction was approved, the merchant 706 may then provide the products purchased by the consumer 704 as part of the payment transaction to the consumer 704.

In some embodiments, once the process 700 has completed, payment from the issuing financial institution 702 to the acquiring financial institution 710 may be performed. In some instances, the payment may be made immediately or within one business day. In other instances, the payment may be made after a period of time, and in response to the submission of a clearing request from the acquiring financial institution 710 to the issuing financial institution 702 via the transaction processing server 702. In such instances, clearing requests for multiple payment transactions may be aggregated into a single clearing request, which may be used by the transaction processing server 712 to identify overall payments to be made by whom and to whom for settlement of payment transactions.

In some instances, the system may also be configured to perform the processing of payment transactions in instances where communication paths may be unavailable. For example, if the issuing financial institution 702 is unavailable to perform authorization of the transaction account (e.g., in step 740), the transaction processing server 712 may be configured to perform authorization of transactions on behalf of the issuing financial institution 702. Such actions may be referred to as “stand-in processing,” where the transaction processing server “stands in” as the issuing financial institution 702. In such instances, the transaction processing server 712 may utilize rules set forth by the issuing financial institution 702 to determine approval or denial of the payment transaction, and may modify the transaction message accordingly prior to forwarding to the acquiring financial institution 710 in step 744. The transaction processing server 712 may retain data associated with transactions for which the transaction processing server 712 stands in, and may transmit the retained data to the issuing financial institution 702 once communication is reestablished. The issuing financial institution 702 may then process transaction accounts accordingly to accommodate for the time of lost communication.

In another example, if the transaction processing server 712 is unavailable for submission of the authorization request by the acquiring financial institution 710, then the transaction processor at the acquiring financial institution 710 may be configured to perform the processing of the transaction processing server 712 and the issuing financial institution 702. The transaction processor may include rules and data suitable for use in making a determination of approval or denial of the payment transaction based on the data included therein. For instance, the issuing financial institution 702 and/or transaction processing server 712 may set limits on transaction type, transaction amount, etc. that may be stored in the transaction processor and used to determine approval or denial of a payment transaction based thereon. In such instances, the acquiring financial institution 710 may receive an authorization response for the payment transaction even if the transaction processing server 712 is unavailable, ensuring that transactions are processed and no downtime is experienced even in instances where communication is unavailable. In such cases, the transaction processor at the acquiring financial institution 710 may store transaction details for the payment transactions, which may be transmitted to the transaction processing server 712 (e.g., and from there to the associated issuing financial institutions 702) once communication between the acquiring financial institution 710 and transaction processing server 712 is reestablished.

In some embodiments, transaction processors may be configured to include a plurality of different communication channels, which may utilize multiple communication cards and/or devices, to communicate with the transaction processing server 712 for the sending and receiving of transaction messages. For example, a transaction processor may be comprised of multiple computing devices, each having multiple communication ports that are connected to the transaction processing server 712. In such embodiments, the transaction processor may cycle through the communication channels when transmitting transaction messages to the transaction processing server 712, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 710 may identify that an authorization request involves an issuing financial institution 702 (e.g., via the bank identification number included in the transaction message) for which no value-added services are required. The transaction processor at the acquiring financial institution 710 may then transmit the authorization request directly to the transaction processor at the issuing financial institution 702 (e.g., without the authorization request passing through the transaction processing server 712), where the issuing financial institution 702 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 712 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 708, acquiring financial institution 710, etc.) for processing using this advanced network, and to quickly and efficiently receive a response regarding the ability for a consumer 704 to fund the payment transaction.

### Computer System Architecture

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device specifically configured to perform the functions discussed herein. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3 and 5-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

The processor device 804 may comprise one or more modules or engines configured to perform the functions of the computer system 800. Each of the modules or engines may be implemented using hardware and, in some instances, may also utilize software, such as corresponding to program code and/or programs stored in the main memory 808 or secondary memory 810. In such instances, program code may be compiled by the processor device 804 (e.g., by a compiling module or engine) prior to execution by the hardware of the computer system 800. For example, the program code may be source code written in a programming language that is translated into a lower level language, such as assembly language or machine code, for execution by the processor device 804 and/or any additional hardware components of the computer system 800. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, systems and methods for generating and using indexing models for neighborhood growth. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for generating a model for indexing neighborhood growth, comprising:
storing, in a transaction database of a processing server, a plurality of transaction messages, wherein each transaction message is formatted based on one or more standards and includes a plurality of data elements including at least a first data element configured to store a geographic location and one or more additional data elements configured to store transaction data, where the geographic location is included in a geographic area of a plurality of geographic areas;
receiving, by a receiving device of the processing server, a data signal electronically transmitted via a communication network, wherein the data signal is superimposed with demographic characteristic data, the demographic characteristic data including at least property value data associated with each geographic area of the plurality of geographic areas;
executing, by a querying module of the processing server, a query on the transaction database to identify a plurality of transaction groups, wherein each transaction group is associated with one of the plurality of geographic areas and includes one or more transaction messages where the geographic location stored in the first data element is included in the respective associated geographic area;
identifying, by a behavioral scoring module of the processing server, one or more purchase behaviors for each of the plurality of geographic areas, wherein the one or more purchase behaviors are based on at least the transaction data stored in the one or more additional data elements included in each transaction message included in the transaction group associated with the respective geographic area; and
generating, by a model generation module, an indexing model configured to calculate an index value for a geographic area indicative of growth or decline of the geographic area based on the identified one or more purchase behaviors and property value data associated with the respective geographic area for each of the plurality of geographic areas.

2. The method of claim 1, wherein the demographic characteristic data further includes a plurality of demographic characteristics associated with each geographic area of the plurality of geographic areas.

3. The method of claim 2, wherein each geographic area of the plurality of geographic areas is associated with a common set of demographic characteristics.

4. The method of claim 1, further comprising:
receiving, by the receiving device of the processing server, a data signal electronically transmitted via the communication network, wherein the data signal is superimposed with social network data, the social network data including at least social activity data associated with each geographic area of the plurality of geographic areas, wherein
the indexing model is further based on the social activity data associated with the respective geographic area for each of the plurality of geographic areas.

5. The method of claim 4, wherein the social activity data includes at least one of: mentions of the associated geographic area, check-ins at a geographic location in the associated geographic area, and selection of content associated with the associated geographic area.

6. A method for identifying an index of neighborhood growth for a neighborhood, comprising:
storing, in a transaction database of a processing server, a plurality of transaction messages, wherein each transaction message is formatted based on one or more standards and includes a plurality of data elements including at least a first data element configured to store a geographic location and one or more additional data elements configured to store transaction data;
storing, in a model database of the processing server, one or more indexing models, wherein each indexing model is configured to calculate an index value for a geographic area indicative of growth or decline of the geographic area based on transaction data associated with the geographic area;
receiving, by a receiving device of the processing server, a data signal electronically transmitted via a communication network, wherein the data signal is superimposed with an index request, the index request including at least a specific geographic area;
executing, by a querying module of the processing server, a query on the transaction database to identify a group of transaction messages where the geographic location stored in the first data element included in each transaction message in the group is included in the specific geographic area;
identifying, by a behavioral scoring module of the processing server, one or more purchase behaviors for the specific geographic area based on at least the transaction data stored in the one or more additional data elements included in each transaction message included in the identified group of transaction messages;
calculating, by an indexing module of the processing server, an index value for the specific geographic area based on application of one of the one or more indexing models to the identified one or more purchase behaviors for the specific geographic area; and
electronically transmitting, by a transmitting device of the processing server, a data signal superimposed with the calculated index value.

7. The method of claim 6, further comprising:
receiving, by the receiving device of the processing server, a data signal electronically transmitted via a communication network, wherein the data signal is superimposed with demographic characteristic data, the demographic characteristic data including at least a plurality of demographic characteristics associated with the specific geographic area, wherein
each indexing model of the one or more indexing models is associated with one or more demographic characteristics, and
the one or more demographic characteristics associated with the one of the one or more indexing models applied to the identified one or more purchase behaviors is included in the plurality of demographic characteristics associated with the specific geographic area.

8. The method of claim 7, wherein the data signal superimposed with demographic characteristic data and the data signal superimposed with the index request are a single data signal.

9. The method of claim 6, further comprising:
receiving, by the receiving device of the processing server, a data signal electronically transmitted via the communication network, wherein the data signal is superimposed with social network data, the social network data including at least social activity data associated with the specific geographic area.

10. The method of claim 9, wherein the calculated index value is further based on application of the one of the one or more indexing models to the social activity data associated with the specific geographic area.

11. A system for generating a model for indexing neighborhood growth, comprising:
a transaction database of a processing server configured to store a plurality of transaction messages, wherein each transaction message is formatted based on one or more standards and includes a plurality of data elements including at least a first data element configured to store a geographic location and one or more additional data elements configured to store transaction data, where the geographic location is included in a geographic area of a plurality of geographic areas;
a receiving device of the processing server configured to receive a data signal electronically transmitted via a communication network, wherein the data signal is superimposed with demographic characteristic data, the demographic characteristic data including at least property value data associated with each geographic area of the plurality of geographic areas;
a querying module of the processing server configured to execute a query on the transaction database to identify a plurality of transaction groups, wherein each transaction group is associated with one of the plurality of geographic areas and includes one or more transaction messages where the geographic location stored in the first data element is included in the respective associated geographic area;
a behavioral scoring module of the processing server configured to identify one or more purchase behaviors for each of the plurality of geographic areas, wherein the one or more purchase behaviors are based on at least the transaction data stored in the one or more additional data elements included in each transaction message included in the transaction group associated with the respective geographic area; and
a model generation module configured to generate an indexing model configured to calculate an index value for a geographic area indicative of growth or decline of the geographic area based on the identified one or more purchase behaviors and property value data associated with the respective geographic area for each of the plurality of geographic areas.

12. The system of claim 11, wherein the demographic characteristic data further includes a plurality of demographic characteristics associated with each geographic area of the plurality of geographic areas.

13. The system of claim 12, wherein each geographic area of the plurality of geographic areas is associated with a common set of demographic characteristics.

14. The system of claim 11, wherein
the receiving device of the processing server is further configured to receive a data signal electronically transmitted via the communication network, wherein the data signal is superimposed with social network data, the social network data including at least social activity data associated with each geographic area of the plurality of geographic areas, and
the indexing model is further based on the social activity data associated with the respective geographic area for each of the plurality of geographic areas.

15. The system of claim 14, wherein the social activity data includes at least one of: mentions of the associated geographic area, check-ins at a geographic location in the associated geographic area, and selection of content associated with the associated geographic area.

16. A system for identifying an index of neighborhood growth for a neighborhood, comprising:
a transaction database of a processing server configured to store a plurality of transaction messages, wherein each transaction message is formatted based on one or more standards and includes a plurality of data elements including at least a first data element configured to store a geographic location and one or more additional data elements configured to store transaction data;
a model database of the processing server configured to store one or more indexing models, wherein each indexing model is configured to calculate an index value for a geographic area indicative of growth or decline of the geographic area based on transaction data associated with the geographic area;
a receiving device of the processing server configured to receive a data signal electronically transmitted via a communication network, wherein the data signal is superimposed with an index request, the index request including at least a specific geographic area;
a querying module of the processing server configured to execute a query on the transaction database to identify a group of transaction messages where the geographic location stored in the first data element included in each transaction message in the group is included in the specific geographic area;
a behavioral scoring module of the processing server configured to identify one or more purchase behaviors for the specific geographic area based on at least the transaction data stored in the one or more additional data elements included in each transaction message included in the identified group of transaction messages;
an indexing module of the processing server configured to calculate an index value for the specific geographic area based on application of one of the one or more indexing models to the identified one or more purchase behaviors for the specific geographic area; and
a transmitting device of the processing server configured to electronically transmit a data signal superimposed with the calculated index value.

17. The system of claim 16, wherein
the receiving device of the processing server is further configured to receive a data signal electronically transmitted via a communication network, wherein the data signal is superimposed with demographic characteristic data, the demographic characteristic data including at least a plurality of demographic characteristics associated with the specific geographic area,
each indexing model of the one or more indexing models is associated with one or more demographic characteristics, and
the one or more demographic characteristics associated with the one of the one or more indexing models applied to the identified one or more purchase behaviors is included in the plurality of demographic characteristics associated with the specific geographic area.

18. The system of claim 17, wherein the data signal superimposed with demographic characteristic data and the data signal superimposed with the index request are a single data signal.

19. The system of claim 16, wherein the receiving device of the processing server is further configured to receive a data signal electronically transmitted via the communication network, wherein the data signal is superimposed with social network data, the social network data including at least social activity data associated with the specific geographic area.

20. The system of claim 19, wherein the calculated index value is further based on application of the one of the one or more indexing models to the social activity data associated with the specific geographic area.
